(19) United States
(12) Patent Application Publication
(10) Pub. No.: US 2009/0033809 A1
(43) Pub. Date: Feb. 5, 2009

(54) PROJECTOR

(75) Inventor: Wen-Wei Tsai, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: CORETRONIC CORPORATION, Hsinchu (TW)

(21) Appl. No.: 11/951,341

(22) Filed: Dec. 6, 2007

(30) Foreign Application Priority Data
Jul. 31, 2007 (TW) 96127934

(51) Int. Cl. H04N 5/64

(52) U.S. Cl. 348/789; 348/E05.128

(57) ABSTRACT

A projector having a wheel module on its case is provided. The wheel module includes a wheel, an encoder, and a microswitch. When the wheel is pressed for a first time, the microswitch outputs a starting signal for turning on the projector. Then, the wheel is rotated for a first time, and the encoder outputs a menu signal for displaying the on screen display (OSD) menu on a screen. Then, when the wheel is rotated again, the encoder outputs a selection signal according to a rotation amount of the wheel for selecting a function or setting a parameter of the OSD menu. When the wheel is pressed again, the microswitch outputs a checking signal for executing a selected function, entering a sub-menu corresponding to the selected function, or storing the parameter.

### CROSS-REFERENCE TO RELATED APPLICATION

This application claims the priority benefit of Taiwan application serial no. 96127934, filed on Jul. 31, 2007. The entirety of the above-mentioned patent application is hereby incorporated by reference herein and made a part of this specification.

### BACKGROUND OF THE INVENTION

1. Field of the Invention

The present invention relates to a projector. More particularly, the present invention relates to a projector using a wheel or a turning knob for selecting functions or setting parameters.

2. Description of Related Art

In the present multi-media society, projectors have been widely used in educations and trainings, business briefings or conference activities, even have become indispensable tools for providing video images in home entertainment.

To provide a pleasing visual effect for a user, a general projector may have an on screen display (OSD) function to display features and parameters of images on a screen, so as to facilitate the user to select the parameters to be adjusted according to requirements. However, along with development of technologies, more and more additional functions are added to the projector. Therefore, for adjusting the OSD menu, number and complexity of keys of the projector are increased.

FIG. 1 is a schematic diagram illustrating a keypad of a conventional projector having an OSD menu. FIGS. 2A˜2C are schematic diagrams illustrating OSD menus of a conventional projector having an OSD menu when functions of the OSD menu being selected. First, referring to FIG. 1, a conventional projector generally includes a keypad 100 comprising a power key 110, an OSD menu key 120, four direction keys 130 and an enter key 140. Therefore, the projector has at least seven keys thereon.

Generally, there is a plurality of subdirectories within the OSD menu, and it has to take a plurality of steps by pressing keys to select one of the parameters to be adjusted when only little adjusting of the images is required. First, referring to FIG. 2A, when a certain function is about to be selected, the OSD menu key 120 is pressed to display the OSD menu arranged in a left-to-right mode on the screen. Then, the left and right direction keys are pressed to select one function. However, operating according to a use intuition of the user generally requires ← and → keys, but there is only − and + keys exist, which does not match the use intuition of the user.

As shown in FIG. 2B, when a function of a main menu is selected, the enter key 140 is pressed for entering a sub-menu. The sub-menu is arranged in a top-to-bottom mode, and therefore ↑ and ↓ direction keys 130 are pressed to select one of the function. Only one option is hopped while pressing the ↑ or ↓ key once. Therefore, if there are many options thereof, the ↑ or ↓ key is pressed repeatedly, which is inconvenient for utilization. Moreover, arranging directions of the main menu and the sub-menu are different, which also does not match the use intuition of the user.

Next, as shown in FIG. 2C, after a function of the sub-menu is selected, the enter key 140 is pressed again to enter the setting frame. Now, arrangement of the menu changes from the top-to-bottom mode to the left-to-right mode, and therefore the + and − keys are pressed to input a suitable value. Each time the + or − key being pressed represents one unit value being added or subtracted. If there are 20 units which a user wants to adjust, the + or − key is pressed 20 times. Thus, adjusting time is too long, and it is inconvenient for utilization.

After the settings are properly adjusted, the enter key 140 is pressed again to store the settings. Then, the OSD menu key 120 is pressed to exit the setting frame, and until now setting of the parameters is completed. As described above, selecting functions or setting parameters of the projector by pressing keys is relatively complicated in operation, which causes inconvenience in utilization.

### SUMMARY OF THE INVENTION

The present invention is directed to a projector, by which a wheel or a turning knob is applied for selecting functions or setting parameters, so as to substitute a keypad of a conventional projector, and improve operation convenience of the projector.

According to an embodiment of the present invention, a projector including a casing, a central processing unit (CPU), a projection module and a wheel module is provided. The casing has an opening. The CPU is disposed in the casing, and generates an on screen display (OSD) menu in response to a menu signal, wherein the OSD menu includes a plurality of functions or a parameter. The projection module is disposed in the casing and coupled to the CPU, and is capable of projecting the OSD menu on a screen. The wheel module is disposed in the casing and coupled to the CPU. The wheel module includes a wheel, an encoder, and a microswitch. A part of the wheel is exposed from the opening. The wheel has a central shaft. One end of the central shaft penetrates the encoder, and the other end of the central shaft is used for turning on the microswitch. When the wheel is pressed for a first time, the microswitch outputs a starting signal for turning on the projector. Then, the wheel is rotated for a first time, and the encoder outputs the aforementioned menu signal for displaying the OSD menu on the screen. When the wheel is rotated again, the encoder outputs a selection signal according to a rotation amount of the wheel for selecting one of the functions or setting the parameter of the OSD menu. When the wheel is pressed again, the microswitch outputs a checking signal for executing a selected function, entering a sub-menu corresponding to the selected function, or storing the parameter.

According to an embodiment of the present invention, another projector is provided. The projector includes a casing, a CPU, a projection module and a turning knob module. The casing has an opening. The CPU is disposed in the casing, and generates an OSD menu in response to a menu signal. The OSD menu comprises a plurality of functions or a parameter. The projection module is disposed in the casing and is coupled to the CPU, and is capable of projecting the OSD menu on a screen. The turning knob module is disposed in the casing and is coupled to the CPU. The turning knob module includes a turning knob, a rotary encoder, and a microswitch. The turning knob is exposed from the opening and is able to rotate the rotary encoder simultaneously. The turning knob is used for turning on the microswitch. When the turning knob is pressed for a first time, the microswitch outputs a starting signal for turning on the projector. Then, the turning knob is rotated for a first time, and the rotary encoder outputs the aforementioned menu signal for displaying the OSD menu on the screen. When the turning knob is rotated again, the rotary encoder outputs a selection signal according to the rotation amount of the turning knob for selecting one of the functions or setting the parameter of the OSD menu. When the turning knob is pressed again, the microswitch outputs a checking signal for executing a selected function, entering a sub-menu corresponding to the selected function, or storing the parameter.

According to the projector of the present invention, a wheel module (or turning knob module) is disposed in the casing of the projector, such that a user is able to select one of the functions or set the parameter by rotating or pressing the wheel (or the turning knob). Therefore, the user may intuitively and quickly adjust the parameters of the projector, and the operation convenience is improved accordingly.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a schematic diagram illustrating a keypad of a conventional projector having an OSD menu.

FIGS. 2A˜2C are schematic diagrams illustrating OSD menus of a conventional projector having an OSD menu when functions of the OSD menu being selected.

FIGS. 3A and 3B are schematic diagrams respectively illustrating a projector according to an embodiment of the present invention, and a system block diagram thereof.

FIGS. 4A˜4C are schematic diagrams illustrating OSD menus of a projector of the present invention when functions of the OSD menu being selected.

FIGS. 5A and 5B are perspective views of a wheel module.

FIG. 6 is a schematic diagram illustrating a projector according to another embodiment of the present invention.

FIG. 7 is a cross-sectional view of the turning knob module of FIG. 6.

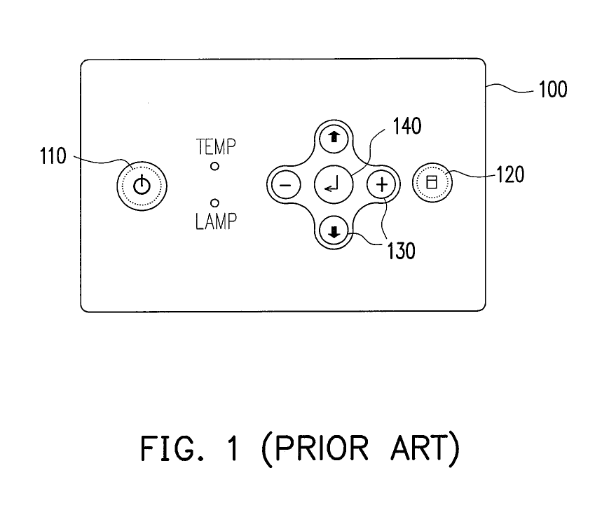

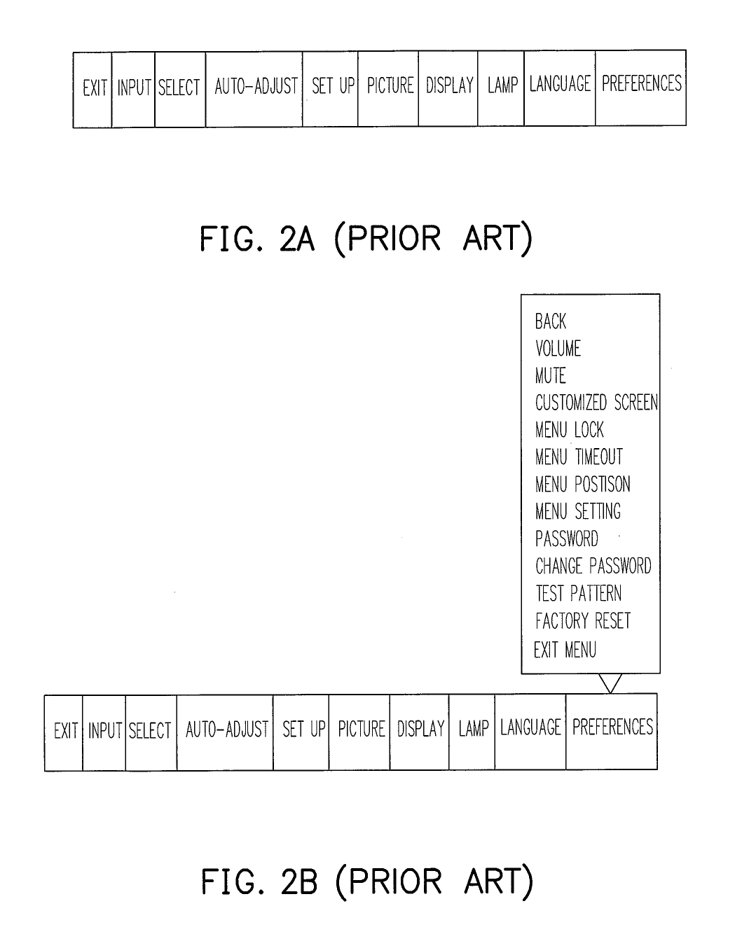

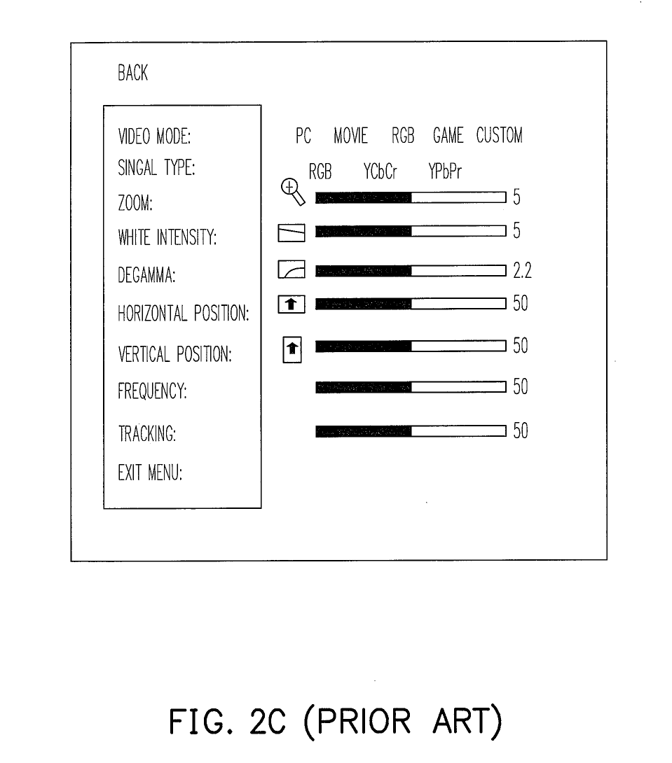

### DESCRIPTION OF EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

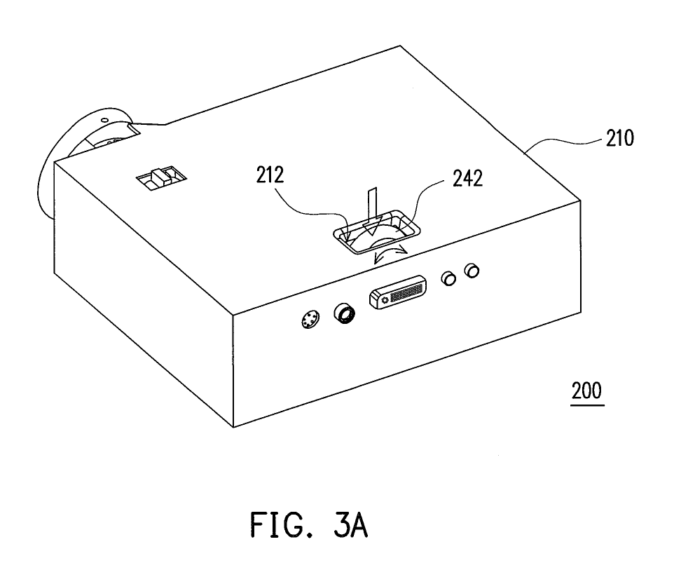

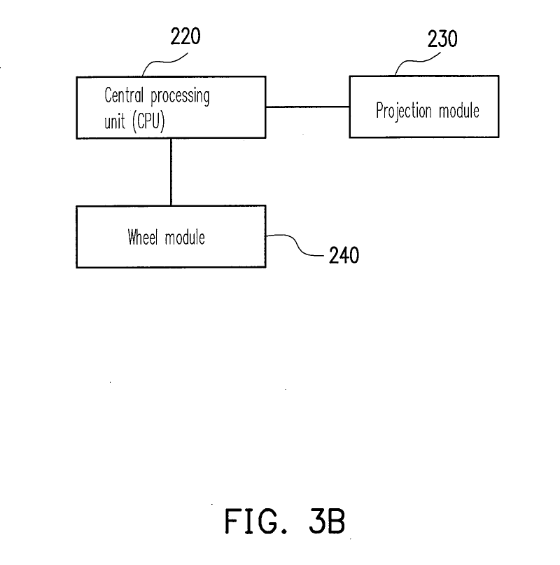

FIGS. 3A and 3B are schematic diagrams respectively illustrating a projector according to an embodiment of the present invention, and a system block diagram thereof. Referring to FIGS. 3A and 3B, a projector 200 mainly includes a casing 210, a central processing unit (CPU) 220, a projection module 230 and a wheel module 240. By applying a wheel module 240 to the projector 200, a user may intuitively and quickly select one of the functions or set the parameters of a on screen display (OSD) menu by rotating or pressing the wheel, such that an operation convenience is improved. Components and connection of the components of the projector 200 are described accompany with the drawings.

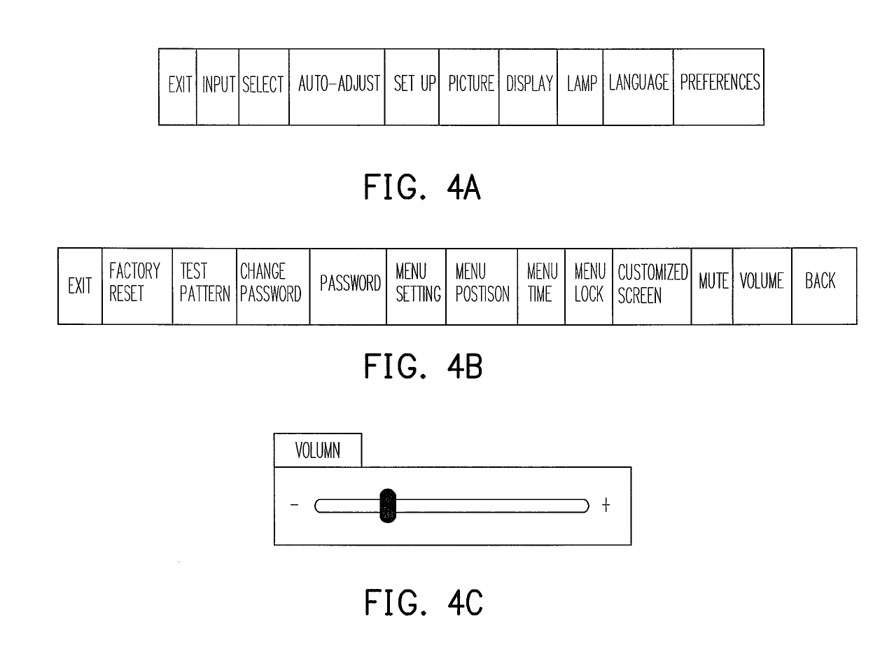

The casing 210 of the projector 200 has an opening 212 for exposing a wheel 242 of the wheel module 240, such that the wheel 242 may be rotated or pressed in a direction of the arrows shown in FIG. 3A. The CPU 220 is disposed in the casing 210 for processing signals, and the CPU 220 may generate the OSD menu as shown in FIG. 4A on a screen in response to a menu signal, wherein the OSD menu includes a plurality of functions or a parameter for the user to select with or set with.

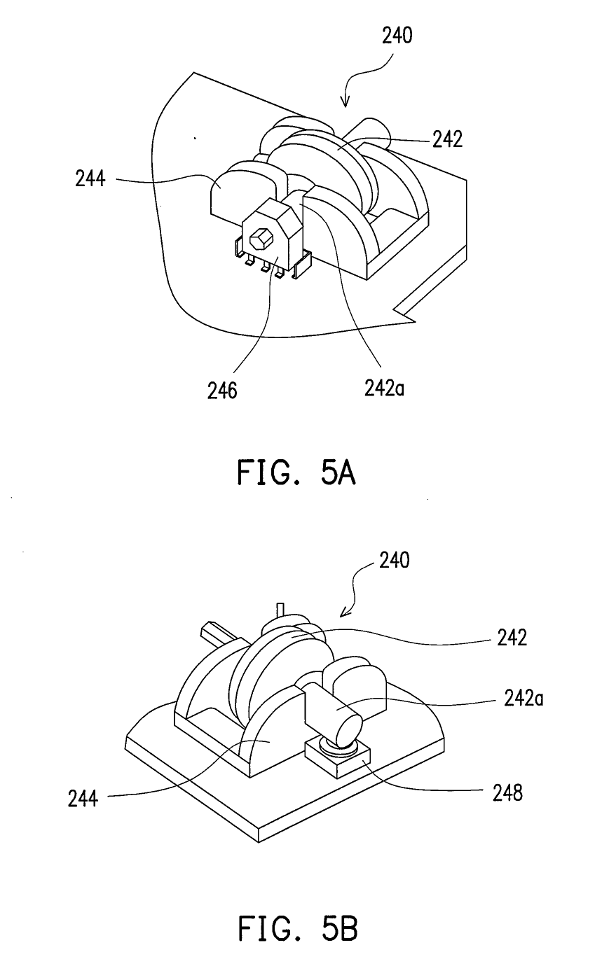

The projection module 230 is disposed in the casing 210 and is coupled to the CPU 220, and is capable of projecting the OSD menu on the screen. The wheel module 240 is disposed in the casing 210 and is coupled to the CPU 220. FIGS. 5A and 5B are perspective views of the wheel module. Referring to FIG. 5A and 5B, the wheel module 240 mainly includes the wheel 242, a wheel carrier 244, an encoder 246, and a microswitch 248. The wheel 242 has a central shaft 242a disposed on the wheel carrier 244, such that the wheel 242 may rotate freely. A part of the wheel 242 is exposed from the opening 212 of the casing 210, such that the wheel 242 may be rotated and pressed. As shown in FIG. 5A, one end of the central shaft 242a penetrates the encoder 246. The encoder 246 has a plurality of phases, and may provide signals to the CPU 220 while rotating with the wheel 242, so as to identify the rotation direction and rotation angle of the wheel 242. As shown in FIG. 5B, the other end of the central shaft 242a is used for turning on the microswitch 248, wherein the microswitch 248 may provide signals to the CPU 220 for identifying the actions of turning on, setting and turning off etc. In the present embodiment, the encoder 246 and the microswitch 248 are disposed on two sides of the wheel 242, respectively. However, the encoder 246 and the microswitch 248 may also be disposed on the same side of the wheel 242, as long as the wheel 242 is capable of turning on the microswitch 248. Configurations of the encoder 246 and the microswitch 248 are not limited by the present invention.

An example will be set forth to demonstrate how to select functions or set parameters of the projector 200 by rotating and pressing the wheel 242.

When the projector 200 is plugged in, the wheel 242 does not function when being rotated. When the wheel 242 is pressed for a first time, the microswitch 248 outputs a starting signal for turning on the projector 200. Then, the wheel 242 is rotated for a first time, and the encoder 246 outputs a menu signal for displaying the OSD menu as shown in FIG. 4A on the screen. If rotation of the wheel 242 is stopped, the OSD menu on the screen disappears after a few seconds; or the wheel 242 may be rotated to select the function “EXIT”, and then the OSD menu may be quitted by pressing the wheel 242 again.

When the OSD menu is displayed on the screen, the wheel 242 may be rotated again, and the encoder 246 may output a selection signal according to a rotation amount of the wheel 242 for selecting a function “PREFERENCES” of the OSD menu. Then, the wheel 242 is pressed again, and the microswitch 248 outputs a checking signal for entering a sub-menu shown as FIG. 4B. If the user wants to quit the sub-menu, the wheel 242 is rotated to select the function “EXIT” of the sub-menu, so as to jump back to the main menu shown as FIG. 4A. If no more functions or parameters are required to be adjusted, rotation of the wheel 242 may be stopped for a while. Then, the adjusted values are stored automatically, and the menu disappears.

If a certain function, for example, “VOLUME” of the sub-menu of FIG. 4B is selected, the wheel 242 is only pressed again. In this case, the microswitch 248 outputs a checking signal for entering a setting frame corresponding to the “VOLUME”, shown as an adjusting bar of FIG. 4C. Then, the wheel 242 is rotated again, and the encoder 246 outputs a selection signal according to the rotation amount of the wheel 242 for adjusting the parameter (volume). When adjusting of the parameter is completed, the wheel 242 is pressed again, and the microswitch 248 outputs the checking signal for storing the adjusted parameter and going back to the sub-menu. Since only rotating and pressing of the wheel 242 are required to be performed for selecting one of the functions or setting the parameters in the OSD menu of the projector 200, operation convenience of the projector 200 is improved. Moreover, in the present embodiment, rotating direction of the wheel 242 is the same to the arrangement direction of the OSD menu. Therefore, the user may intuitively and quickly adjust the parameters of the projector 200, such that quick adjustment of the parameters is achieved.

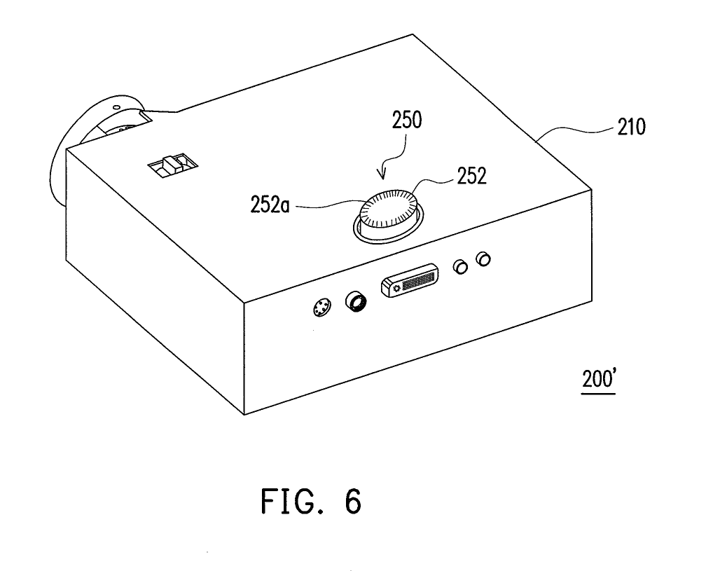

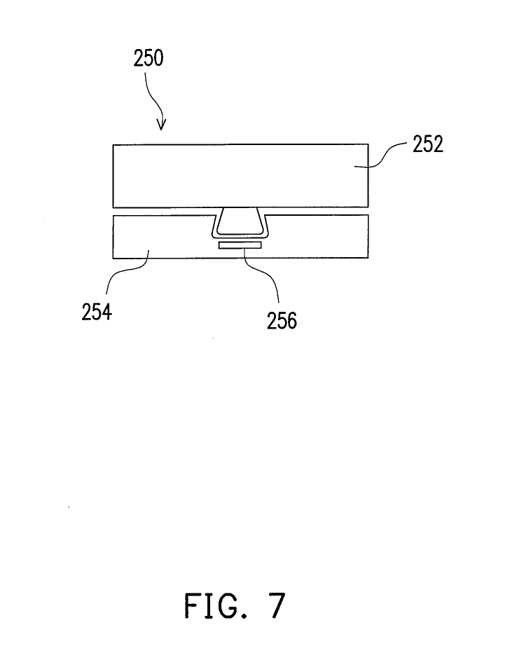

FIG. 6 is a schematic diagram of a projector according to another embodiment of the present invention. Referring to FIG. 6, the structure and composition of the projector 200′ is similar to that of the projector 200 of FIG. 3A, and therefore detailed description will not be repeated. The difference there between is that a turning knob module 250 is disposed on the casing 210 of the projector 200′. FIG. 7 is a cross-sectional view of the turning knob module of FIG. 6. Referring to FIG. 7, the turning knob module 250 includes a turning knob 252, a rotary encoder 254 and a microswitch 256. The turning knob 252 is exposed from the opening 212 of FIG. 6 and may rotate the rotary encoder 254 simultaneously. The turning knob 252 is capable of turning on the microswitch. Therefore, a user may also intuitively select one of the functions or set the parameters of the OSD menu by rotating or pressing the turning knob 252. Operation of the turning knob module 250 is the same to that of the aforementioned wheel module 242, and therefore detailed description will not be repeated. Moreover, to facilitate operation of the turning knob 252, the turning knob 252 can be designed to protrude out of the casing 210 or to be co-planar with the surface of the casing 210, and slide-proof lines 252a may also be added to the surface of the turning knob 252, so as to facilitate the operators.

In summary, the projector of the present invention applies a wheel module (or turning knob module) on the casing, such that the user may select the one of the functions or set the parameters by rotating or pressing the wheel (or the turning knob), and by such means, a keypad of a conventional projector is substituted. Accordingly, the user may intuitively and quickly adjust the parameters of the projector, the operation convenience is improved, and a sense of design of the projector is also improved.

In addition, compared with the keypad of the conventional projector, the wheel module (or the turning knob module) of the present invention has the advantages of less occupation of space, fewer components included and easy assembling. Therefore, problems caused by arranging of the plurality of keys can be avoided, and production cost of the projector may be reduced. Accordingly, production yield is improved.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A projector, comprising:
a casing, having an opening;
a central processing unit, disposed in the casing, the central processing unit generating an on screen display menu in response to a menu signal, and the on screen display menu comprising a plurality of functions or a parameter;
a projection module, disposed in the casing and coupled to the central processing unit, and the projection module being capable of projecting the on screen display menu on a screen; and
a wheel module, disposed in the casing and coupled to the central processing unit, the wheel module comprising a wheel, an encoder and a microswitch, wherein a part of the wheel is exposed from the opening, the wheel for turning on the microswitch has a central shaft, and one end of the central shaft penetrates the encoder;
wherein when the wheel is pressed for a first time, the microswitch outputs a starting signal for turning on the projector; then, the wheel is rotated for a first time, and the encoder outputs the menu signal for displaying the on screen display menu on the screen; when the wheel is rotated again, the encoder outputs a selection signal according to a rotation amount of the wheel for selecting one of the functions or setting the parameter; and when the wheel is pressed again, the microswitch outputs a checking signal for executing a selected function, entering a sub-menu corresponding to the selected function, or storing the parameter.

2. The projector as claimed of claim 1, wherein the wheel module further comprises a wheel carrier, the wheel is disposed on the wheel carrier, and is able to rotate on the wheel carrier via the central shaft.

3. A projector, comprising:
a casing, having an opening;
a central processing unit, disposed in the casing, the central processing unit generating an on screen display menu in response to a menu signal, and the on screen display menu comprising a plurality of functions or a parameter;
a projection module, disposed in the casing and coupled to the central processing unit, and the projection module being capable of projecting the on screen display menu on a screen; and
a turning knob module, disposed in the casing and coupled to the central processing unit, the turning knob module comprising a turning knob, an rotary encoder and a microswitch, wherein the turning knob is exposed from the opening, and is capable of driving the rotary encoder to rotate, and the turning knob being used for turning on the microswitch;
wherein when the turning knob is pressed for a first time, the microswitch outputs a starting signal for turning on the projector; then, the turning knob is rotated for a first time, and the rotary encoder outputs the menu signal for displaying the on screen display menu on the screen; when the turning knob is rotated again, the rotary encoder outputs a selection signal according to a rotation amount of the turning knob for selecting one of the functions or setting the parameter; and when the turning knob is pressed again, the microswitch outputs a checking signal for executing a selected function, entering a sub-menu corresponding to the selected function, or storing the parameter.

4. The projector as claimed in claim 3, wherein the turning knob protrudes out of the casing.

5. The projector as claimed in claim 3, wherein the turning knob is co-planar with a surface of casing.

6. The projector as claimed in claim 3, wherein the turning knob has slide-proof lines on a surface of the turning knob.
